(19) United States
(12) Patent Application Publication
(10) Pub. No.: US 2026/0159382 A1
(43) Pub. Date: Jun. 11, 2026

(54) H2 PRODUCTION FROM HUMID AIR USING PLASMA IN THE PRESENCE OF AN ADSORBENT AND/OR CATALYST

(71) Applicant: The Board of Trustees of the University of Illinois, Urbana, IL (US)

(72) Inventor: Chinmoy BAROI, Urbana, IL (US)

(73) Assignee: The Board of Trustees of the University of Illinois, Urbana, IL (US)

(21) Appl. No.: 19/415,405

(22) Filed: Dec. 10, 2025

Related U.S. Application Data
(60) Provisional application No. 63/730,671, filed on Dec. 11, 2024.

(51) Int. Cl. C01B 3/042; C01B 3/047; C01B 3/26

(52) U.S. Cl. CPC C01B 3/045; C01B 3/047; C01B 3/26; C01B 2203/0277; C01B 2203/042; C01B 2203/1241

(57) ABSTRACT

Provided are methods of converting a water-containing gas into at least hydrogen gas, including by flowing the water-containing gas through a gas flow cell having an inlet, an outlet, and a structured material positioned within the gas flow cell. In some embodiments, the structured material has an electrical conductivity selected from the range of 3×10⁻¹⁵ S/m to 6.3×10⁷ S/m. In some embodiments, the structured material is a sorbent and/or catalyst material. Generating a plasma within a portion of the gas flow cell, wherein the plasma at least partially interacts with the water-containing gas and the structured material, causes conversion of the gas to generate H₂.

### CROSS-REFERENCE TO RELATED APPLICATIONS

This application claims the benefit of priority to U.S. Provisional Patent Application No. 63/730,671, filed Dec. 11, 2024, which is hereby incorporated by reference in its entirety.

### BACKGROUND OF THE INVENTION

Hydrogen gas (H₂) is an attractive fuel source, as its consumption produces only H₂O. Currently H₂ production primarily involves fossil fuels, such as steam methane reforming, a process that generates significant environmentally harmful CO₂.

Alternatively, water electrolysis offers a cleaner path, producing oxygen (O₂) as a byproduct. However, electrolysis demands a clean water source to be effective, necessitating expensive production and pretreatment. Accordingly, there is a need in the art for efficient and reliable production of hydrogen gas from a gas that does not require extensive pretreatment related to the water component.

Provided herein are novel methods and systems for generating hydrogen from water-containing gases, including from ambient moisture in the atmosphere. This approach eliminates the need for a water source and its pretreatment. Additionally, the described methods are capable of simultaneously capturing CO₂.

U.S. patent application Ser. No. 18/977,015 (Pub. No. 2025-0320126) describes various methods for releasing or converting a gas, including with gas flow cells, structured material and plasma. The instant methods and systems provided herein address the need in the art for generating hydrogen gas (H₂) by use of a sorbent and/or catalytic material (more generally referred to as a structured material) to adsorb H₂O from a gas and generate H₂ from the H₂O.

### SUMMARY OF THE INVENTION

Provided herein are systems and methods of converting a gas, including generation of hydrogen gas from water in the gas. In some embodiments, a method of converting a gas includes flowing the gas through a gas flow cell having an inlet, an outlet, and a structured material with the gas flow cell. In some embodiments, the structured material has an electrical conductivity selected from the range of 3×10⁻¹⁵ S/m to 6.3×10⁷ S/m. In some embodiments, the structured material acts as an electrode. In some embodiments, the structured material is a sorbent and/or catalytic material. In some embodiments, the gas comprises H₂O. In some embodiments, the sorbent and/or catalytic material adsorbs the H₂O from the gas. In some embodiments, the method further includes generating a plasma within a portion of the gas flow cell, wherein the plasma at least partially interacts with the gas and the structured material, thereby causing conversion of the gas, wherein the conversion of the gas generates H₂. In some embodiments, the H₂O adsorbed to the sorbent and/or catalytic material generates H₂ gas when the plasma interacts with the H₂O, including via application of an electric current that generates the plasma.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Graph showing the concentration of CO₂ over time while turning the plasma on (left dotted line) and off (right dotted line) using an exemplary apparatus as illustrated in FIGS. 6A-6B and FIG. 7. A flow rate of 30 sccm (standard cubic centimetres per minute) with a gas comprising 10% CO₂ was used. A DC plasma is formed by providing a voltage of 6 V with a current of 2 A to the electrodes. The section labeled 1 shows the increase of the concentration of CO₂ after the plasma is turned on due to the desorption of the CO₂ from the structured material. The section labeled 2 shows a decline in the concentration of CO₂ due to the consumption of the CO₂. The section labeled 3 shows a return to the baseline concentration of the CO₂ after the plasma is turned off due to the adsorption of CO₂ onto the structured material.

FIGS. 2A-2D: Graphs showing the CO₂ adsorption (mmol/g), CO₂ conversion %, CO₂ desorption %, H₂ generation (mmol/g), and O₂ generation (mmol/g) at various flow rate and currents using an exemplary apparatus as illustrated in FIGS. 6A-6B, 7. FIG. 2A shows the above parameters using a flow rate of 30 sccm at a voltage of 6 V and a current of 2 A. FIG. 2B shows the above parameters using a flow rate of 30 sccm at a voltage of 6 V and a current of 1.2 A. FIG. 2C shows the above parameters using a flow rate of 40 sccm at a voltage of 6 V and a current of 2 A. FIG. 2D shows the above parameters using a flow rate of 40 sccm at a voltage of 6 V and a current of 1.2 A.

FIGS. 3A-3D: Graphs showing the formation of formaldehyde and methanol over time while turning the plasma on (left dotted line) and off (right dotted line) using an exemplary apparatus as illustrated in FIGS. 6A-6B, 7. FIG. 3A shows the formation of formaldehyde using a flow rate of 30 sccm. FIG. 3B shows the formation of methanol using a flow rate of 30 sccm. FIG. 3C shows the formation of formaldehyde using a flow rate of 40 sccm. FIG. 3D shows the formation of methanol using a flow rate of 40 sccm.

FIG. 4: Graph comparing the CO₂ adsorption, CO₂ conversion, CO₂ desorption, H₂ generation, and O₂ generation in the presence of moisture (left) and in the absence of moisture (right) using an exemplary apparatus as illustrated in FIGS. 6A-6B, 7. A flow rate of 30 sccm with a gas comprising 10% CO₂ was used. A DC plasma was formed by providing a voltage of 6 V with a current of 2 A to the electrodes.

FIGS. 5A-5D: Graphs comparing the values of CO₂ desorption (FIG. 5A), CO₂ adsorption (FIG. 5B), H₂ production (FIG. 5C), and O₂ production (FIG. 5D) with changes in the CO₂ concentration in the gas.

FIG. 6A: Image of a gas flow cell and plasma generator with structured catalysts positioned in the gas flow cell. FIG. 6B: Close-up image of an electrode creating a plasma in the gas flow cell of FIG. 6A.

FIG. 7: Schematic illustration of a gas flow cell configured to accommodate a plasma along with structured material, including catalysts. An electrically-conductive wire bunch, such as copper wires, is used as an electrode.

FIG. 8A: Illustration of an exemplary structured material. The structure comprises mesopores that in turn comprise micropores. An SEM image of a sample of the exemplary material is also shown. FIG. 8B: Illustration of an exemplary gas flow cell containing a structured material. The structured material may be constructed using additive manufacturing techniques, e.g., 3D printing. In some examples, the gas from the outlet may be analyzed using a mass spectrometer. FIG. 8C: Images of an exemplary DC arc plasma reactor system in both ambient light (left) and in darkness (right).

FIGS. 9A-9D: Graphs showing CO₂ desorption (FIG. 9A), H₂O production (FIG. 9B), H₂ production (FIG. 9C), and O₂ production (FIG. 9D) as the plasma is turned on (left dotted line) and off (right dotted line).

FIG. 10: Illustration of a gas flow cell with a structured material corresponding to activated carbon foam for CO₂ activation and conversion under a plasma reaction.

FIG. 11: Illustration of a gas flow cell with a structured material corresponding to activated carbon foam for H₂ production from humid air under a plasma reaction.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

The term “gas flow cell” refers to a volume of space through which a gas may be flowed, including a water-containing gas. In some examples, a gas flow cell may comprise an inlet and an outlet for flowing a gas through the gas flow cell. In some examples, a gas flow cell may be constructed from any suitable material, including, but not limited to, glass, plastic, or metal. Preferably, the gas flow cell material is chemically inert under the operating conditions with respect to the water-containing gas.

The term “structured material” refers to a material that has a structure. In some examples, a structured material may have a monolithic structure, a foam structure, or a corrugated sheet structure. In some examples, a structured material may have a periodic Open Cell Structure (POCS), for example, a Kelvin POCS, a cubic POCS, a diamond POCS, or a hybrid POCS. In some embodiments, the structured material includes, but is not limited to, a metal foam, a ceramic, a silicon carbide, a metal carbide, a porous carbon, a carbon foam, a metallic alloy mesh, a porous single or mixed oxide, a porous composite, an engineered designed porous composite, a polyaniline-based porous carbon, a hierarchical n-doped carbon, a coated adsorbent, and/or a coated catalyst. Optionally, the structured material is a combination of a sorbent material and a catalyst material, including any of the sorbents and catalysts described herein.

The term “plasma” refers to an ionized substance characterized by the presence of a significant portion of charged particles. In some examples, a plasma may be generated by applying an electric or magnetic field through a gas. In some examples, the charged particles may comprise ions and/or electrons. In some examples, the plasma is only partially ionized, due to the presence of neutral particles. In some examples, plasmas may demonstrate a high electrical conductivity.

The term “plasma source” refers to a power source electrically connected to two electrodes. The power source provides a voltage and current sufficient to produce a plasma through the gas between the electrodes. In some examples, the power source may be a direct current (DC) power source or an alternating current (AC) power source. In some examples, the plasma source may produce an arc plasma.

The term “power source” refers to a device capable of generating an electric current. In some examples, the power source may be a direct current (DC) power source or an alternating current (AC) power source. In some examples, the power source may be part of a plasma source. In some examples, the power source may be used to induce resistive/joule heating.

The term “sorbent material” refers to a structured material that absorbs and/or adsorbs liquids and/or gases. In some examples, the sorbent material may have a high affinity for certain materials, while lacking as high of an affinity for other materials. For example, a sorbent material may have a high affinity for carbon dioxide gas, nitrogen gas, hydrogen gas, methane gas, ammonia gas. Optionally, the sorbent material is one or more of: carbon foam, including carbon foam having a KOH to foam treatment ratio by mass of between 2:1 and 6:1 at a treatment temperature of between 650° C. and 850° C.; basic metal or metal oxides (e.g., Mg) coated carbon foam, basic metal or metal oxides (e.g., Mg) coated ceramics, basic metal or metal oxides (e.g., Mg) coated silica carbides, structured MOF, structured zeolites, hydrotalcites, etc.

The term “catalyst” or “catalytic” are used interchangeable to refer to a material or substance that increases the rate of a chemical reaction. In some examples, a catalyst may increase the rate by providing an alternative reaction pathway with an activation energy lower than what is available without the catalyst. In some examples, a catalyst may be a heterogeneous catalyst (i.e., a catalyst that is in a different phase of matter than the reactants), or a homogenous catalyst (i.e., a catalyst that is in the same phase of matter as the reactants). Optionally, the catalyst contains one or more of: Cu, Ni, Co, La, Mg, Ru, Ag, Fe, Mo, Pt, Au, etc.

The term “photocatalyst” refers to a catalyst that increases the rate of a photochemical reaction. In some examples, a photocatalyst may absorb light and enter an excited state. The excited state of the photocatalyst may interact with the reactants, thereby forming reaction intermediates and regenerating itself after each interaction.

The term “DC current plasma” refers to a plasma generated by applying a direct current (DC) through a gas. In some examples, the DC may be generated using a DC power source.

The term “AC current plasma” refers to a plasma generated by applying an alternating current (AC) through a gas. In some examples, the AC may include a radio frequency (RF) component.

The term “arc plasma” refers to a plasma generated by creating an electric arc between two electrodes. In some examples, such an arc can be initiated by ionization and glow discharge, when the current through the electrodes is increased. In some examples, such an arc can be initiated by two electrodes initially in contact and subsequently drawn apart. In some examples, an arc plasma may be formed using either a direct current (DC) or an alternating current (AC) power source. An arc plasma is different than a glow discharge plasma.

The term “resistive/joule heating” refers to the process of heating an element via the heat generated by the passage of an electric current through a conductive material. In some examples, a structured material may be pre-treated using resistive/joule heating.

The term “pre-treat” refers to the preparation of a structured material for use in a chemical or physical reaction. In some examples, the pre-treatment may include heating the structured material, for example, using resistive/joule heating.

The term “carbon foam” refers to a material or structure comprising solid carbonaceous material with gas-filled pores, wherein the gas-filled pores comprise a large portion of the volume. Optionally, the gas-filled pores may comprise at least 75%, at least 80%, at least 82.5%, at least 85%, at least 87.5% at least 90%, at least 92.5%, or at least 95% of the material.

The term “sccm” when used in a flow rate refers to standard cubic centimeters per minute. Said another way, 1 sccm is equivalent to 1 cm³ of fluid per minute at standard temperature and pressure.

The term “standard temperature and pressure” refers to a pressure of approximately 1 bar and a temperature of approximately 273.15 K. For example, the pressure may be within 0.01%, 0.1%, 1%, 2%, 3%, 4%, 5%, 6%, 7%, 8%, 9%, or 10% of 1 bar. Similarly, the temperature may be within 0.01%, 0.1%, 1%, 2%, 3%, 4%, 5%, 6%, 7%, 8%, 9%, or 10% of 273.15 K.

In the following description, numerous specific details of the devices, device components and methods of the present invention are set forth in order to provide a thorough explanation of the precise nature of the invention. It will be apparent, however, to those of skill in the art that the invention can be practiced without these specific details.

U.S. Pat. Pub. No. 2025/0320126 (application Ser. No. 18/977,015) is specifically incorporated by reference herein for any of the apparatus, systems, or methods described therein, including for the conversion of a gas, plasma generation and structured materials (sorbent and/or catalytic materials).

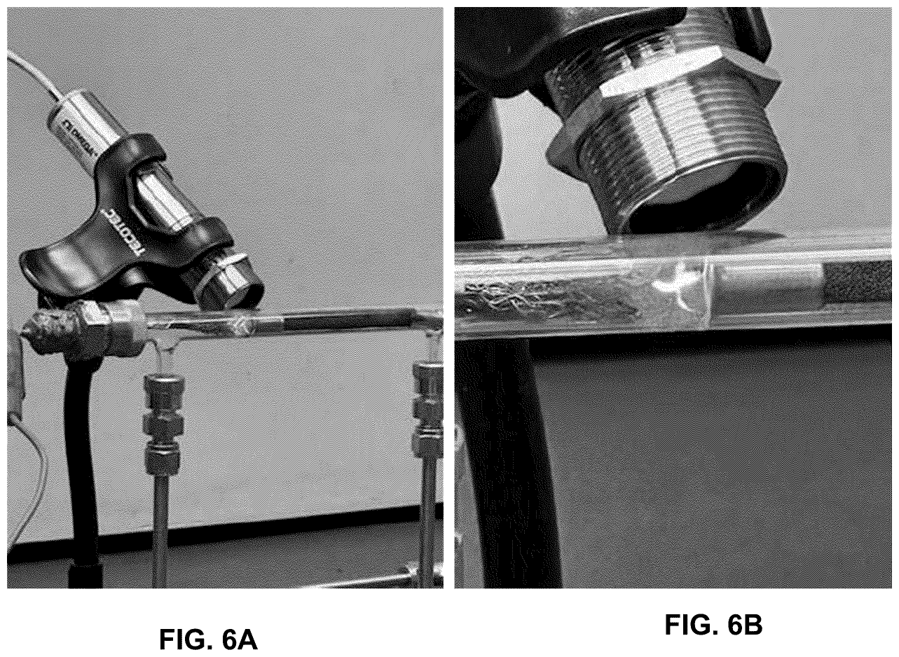

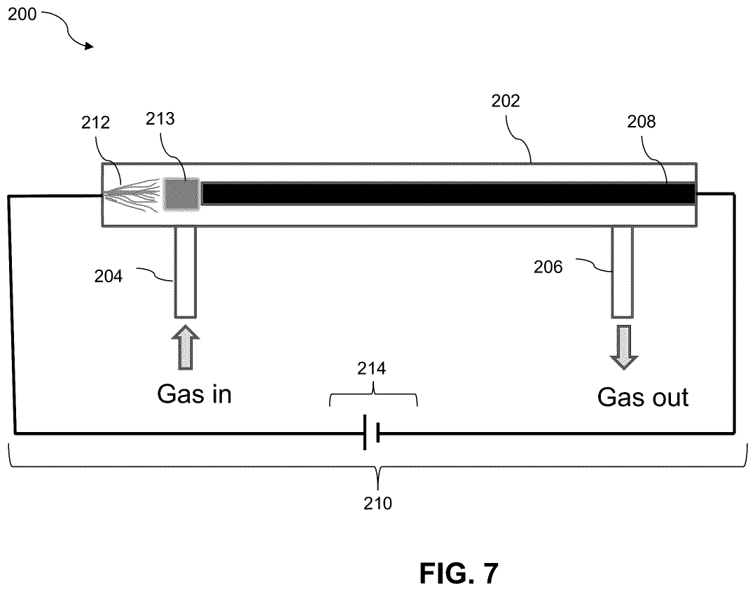

FIGS. 6A-6B are close-up images of an exemplary apparatus 200, for converting a gas, including a water-containing gas. The apparatus is configured to generate and accommodate a plasma.

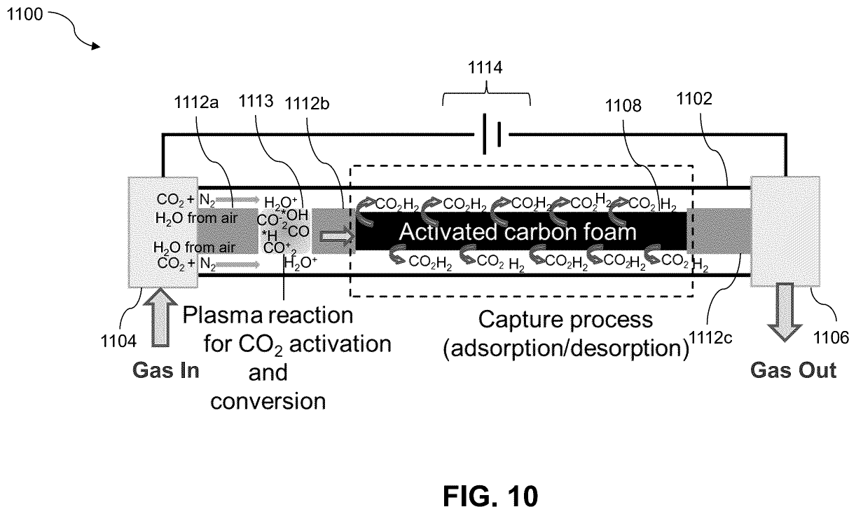

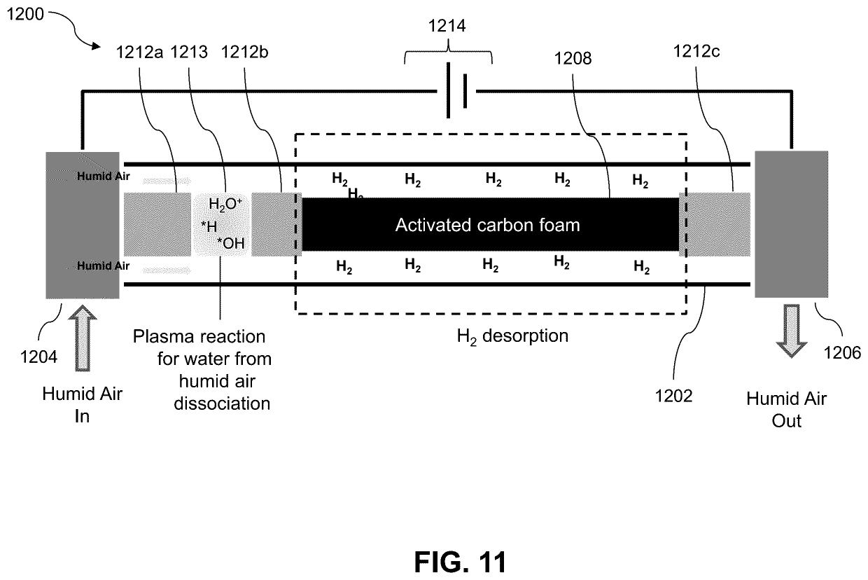

FIG. 7 is an illustration of another exemplary apparatus 200. Apparatus 200 comprises a gas flow cell 202 with an inlet 204 and an outlet 206. A structured material 208 may comprise a structured catalyst positioned in the gas flow cell 202. A plasma source 210 is integrated with gas flow cell 202 and is configured to generate a DC arc plasma, such as from a high power voltage source 214 within a portion of gas flow cell 202, including as illustrated in plasma reaction region 213 (see also 1113 and 1213 at FIGS. 10-11, respectively). Plasma source 210 comprises electrode 212 within gas flow cell 202. In some embodiments, electrode 212 comprises a plurality of electrically-conductive wires, such as copper wires. In some embodiments, the electrically conductive wires may be described as each of the wires in the wire bunch independently has a thickness of between 0.2 mm and 2 mm, such as at least 0.25 mm, at least 0.5 mm, at least 0.75 mm, or at least 1 mm. In some embodiments, each of the wires in the wire bunch independently has a thickness of at most 1 mm, at most 0.75 mm, at most 0.5 mm, or at most 0.25 mm. Optionally, the thickness of each of the wires in the wire bunch may be independently selected from the range of 0.5 mm to 1 mm. In some embodiments, the wire bunch may be characterized by a total number of wires, such as between 5 and 100 wires, including at least 5, at least 10, at least 15, at least 20, at least 25, or at least 30 wires. In some embodiments, the wire bunch may comprise at most 30, at most 25, at most 20, at most 15, at most 10, or at most 5 wires. Optionally, the number of wires comprising the wire bunch may be selected from the range of 10 to 30 copper wires. Power source 214 is configured to provide a DC voltage to electrode 212 and structured material 208.

In some embodiments, a resistive/joule heating source (not shown) may be in thermal communication with structured material 208, and be configured to pre-treat structured material 208. For example, electrode 212 may be in electrical communication with structured material 208 and may function as a resistive/joule heating element.

As discussed further in the examples below, the apparatus can be used to generate H₂ from humid air (more generally referred herein as a water-containing gas).

The invention can be further understood by the following non-limiting examples.

### Example 1: Capture and In-Situ Conversion of CO₂ Using Novel Plasma Technology Under Ambient Conditions

### Materials

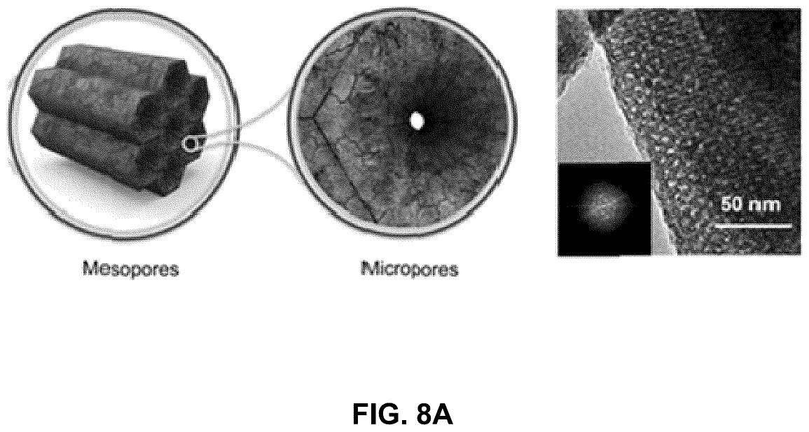

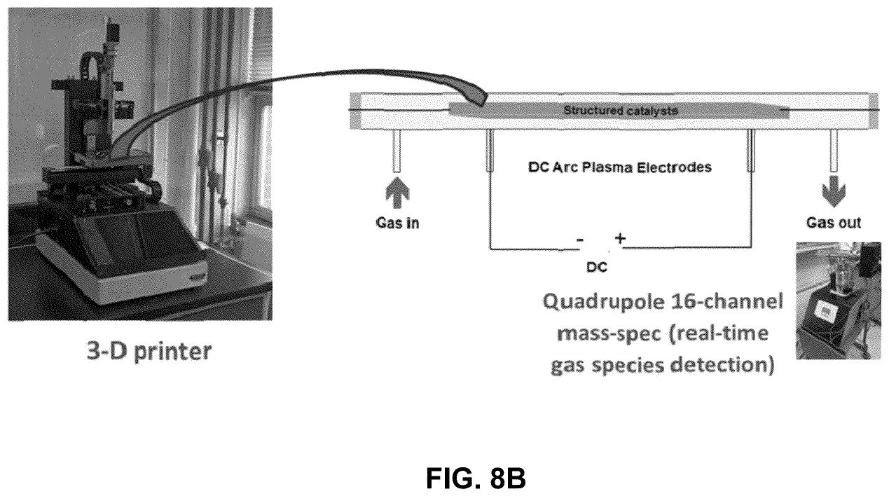

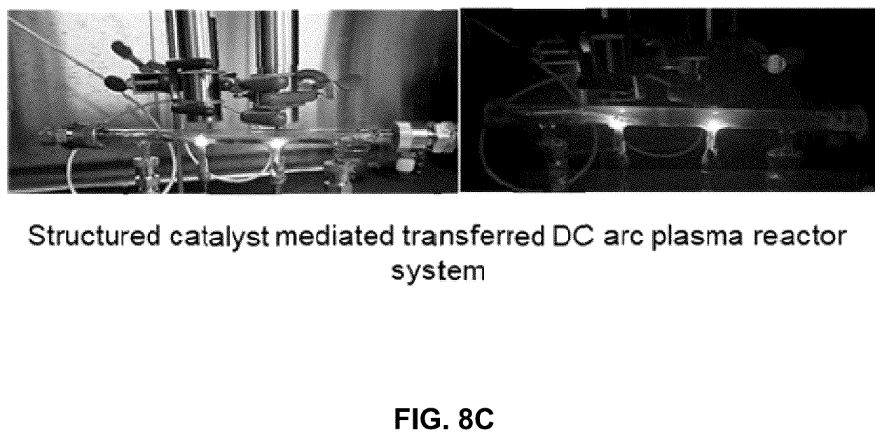

As is shown in FIG. 8A, a structured material for use in an embodiment of the present invention, e.g., activated carbon foam, is made of a high-surface area carbon comprising mesopores and/or micropores. In some embodiments, the mesopores may be characterized by an average pore diameter of between 2 nm-50 nm. In some embodiments, the micropores have an average pore diameter of less than or equal to 2 nm.

Referring now to FIG. 8B, the structured material may be a catalyst. The structured material may be synthesized using additive manufacturing techniques, e.g. 3D printing. In one embodiment, activated carbon foam was prepared using the following method. Commercial carbon foam was cut into electrode shapes, and a 3:1 mass ratio KOH solution was prepared by dissolving KOH in water. The foam pieces were immersed in the solution, ensuring full coverage, and soaked for 2 hours with agitation. The pieces were dried in a calcination oven at 90° C. for 6 hours. Subsequently, they were placed in an alumina dish within a tube furnace, purged with N₂ for 30 minutes, and heated at a rate of 5° C./min to 700° C., held at this temperature for 1 hour, and then cooled to room temperature. The foam was washed with 10 wt. % HCl until neutral pH was achieved and dried again at 90° C. for 6 hours.

### Experimental Set-Up

The experimental setup comprises two mass flow meters (Alicat Scientific), a plasma reactor, a DC power supply (Kiprim DC310S), an infrared (IR) camera (Omega OS136A), optical components for spectroscopy (Ocean optics HR-2XR300-25), and a mass spectrometer (Extrel MAX300-CAT). The reactor employs a porous activated carbon foam strip as an electrode for plasma generation. The foam strip is housed in a quartz tube (12 mm or 0.5 inch in diameter). Plasma is generated in a 2.5-inch blank region formed between the activated carbon foam and a copper electrode connected to the negative terminal of the power supply. A brush-shaped electrode, also connected to the power supply, completes the plasma region. The IR camera measures the plasma region's temperature, while optical components are used for absorbance and emission spectroscopy.

The activated carbon foam strip is loaded into the reactor, with its right end connected to an electrical terminal. Both ends of the quartz tube are sealed, ensuring the gas inlet/outlet remains connected. N₂ gas is flowed at a target rate for at least 45 minutes at room temperature. Subsequently, CO₂ is introduced into the setup at a controlled flow rate until a steady state (plateau) is observed, as confirmed by mass spectrometry.

The gas outlet of the reactor may be configured to be in communication with a gas species detector, e.g., a mass spectrometer. The gas species detector may be capable of real-time detection of multiple gas species. For example, the gas species detector may be capable of real-time detection of a plurality of gas species, such as up to 16 gas species. The gas species detected may include, for example, CO₂, O₂, H₂O, H₂, and any combination thereof.

To generate plasma, a DC voltage of 6 V is applied, and experiments are conducted at current settings of 1.2 A, 1.5 A, and 2.0 A. After each experiment, a cooling period of 10 minutes is allowed to prevent overheating of the high-voltage generator and to ensure surface saturation with CO₂. Stabilization of the setup is verified by monitoring the plateau state using the mass spectrometer.

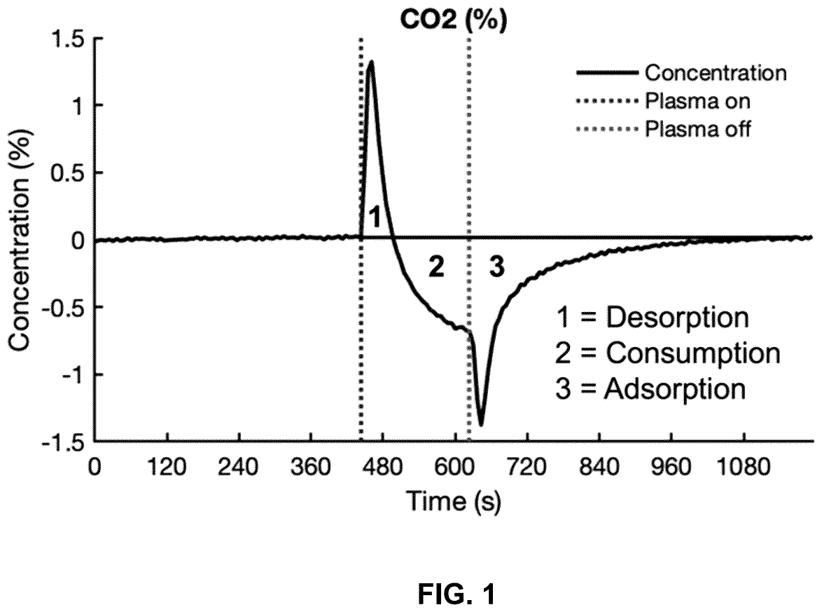

Upon initiating the plasma, as illustrated in FIG. 1, the concentration of CO₂ increases due to the injection of plasma energy. In Area 2 of FIG. 1, a decline in CO₂ concentration is observed. Following the deactivation of the plasma, indicated by the red line, the concentration exhibits a narrow peak before gradually returning to its original level. In this study, Areas 1, 2, and 3 are defined as desorption, consumption, and adsorption phases, respectively.

CO₂ adsorption, in this context, refers to the amount of CO₂ adsorbed by activated carbon after the plasma reaction has ceased. The activated carbon, functioning as an electrode, is energized by electricity during plasma activation. During this process, it acts as a sink for CO₂. The findings indicate that the extent of CO₂ adsorption increases proportionally with the CO₂ concentration.

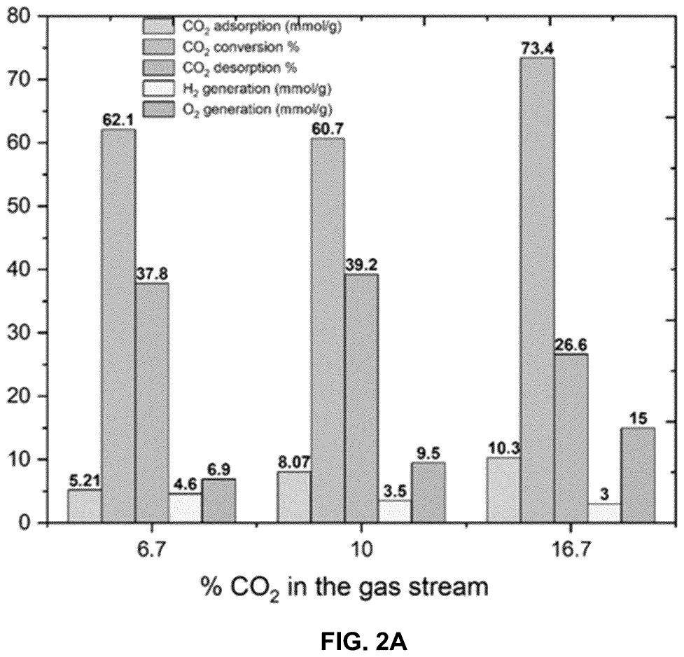

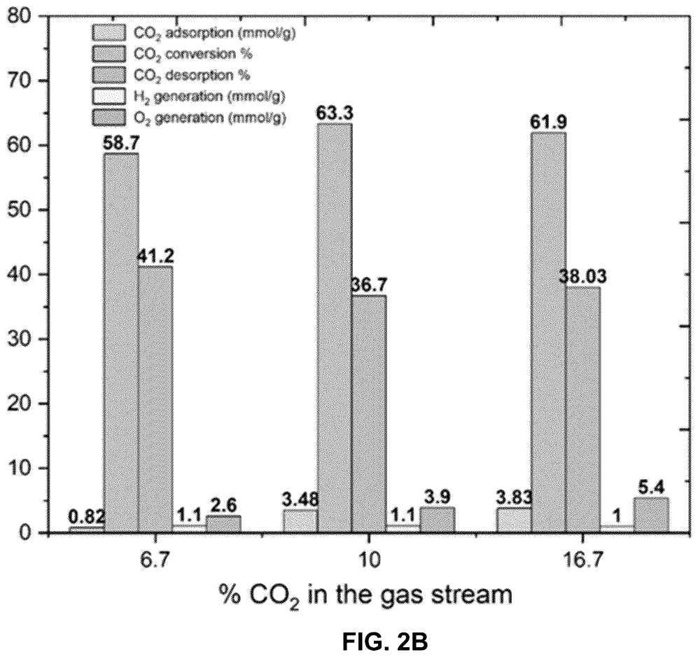

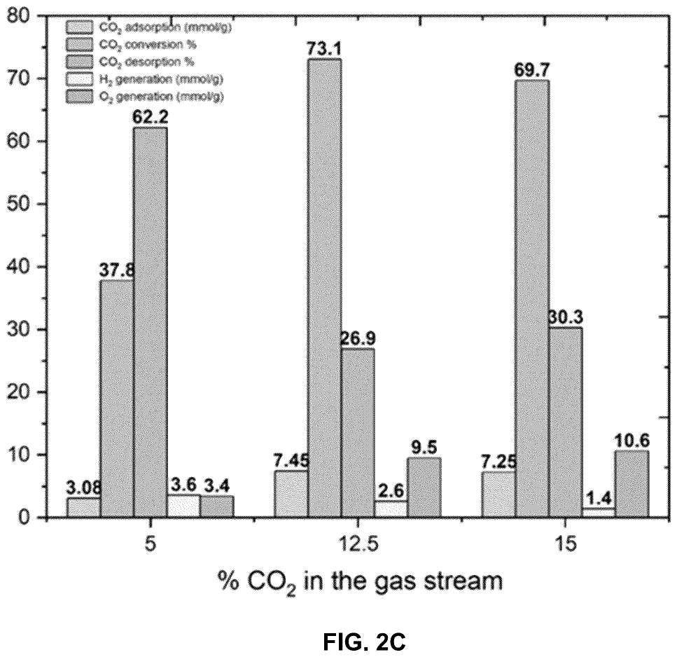

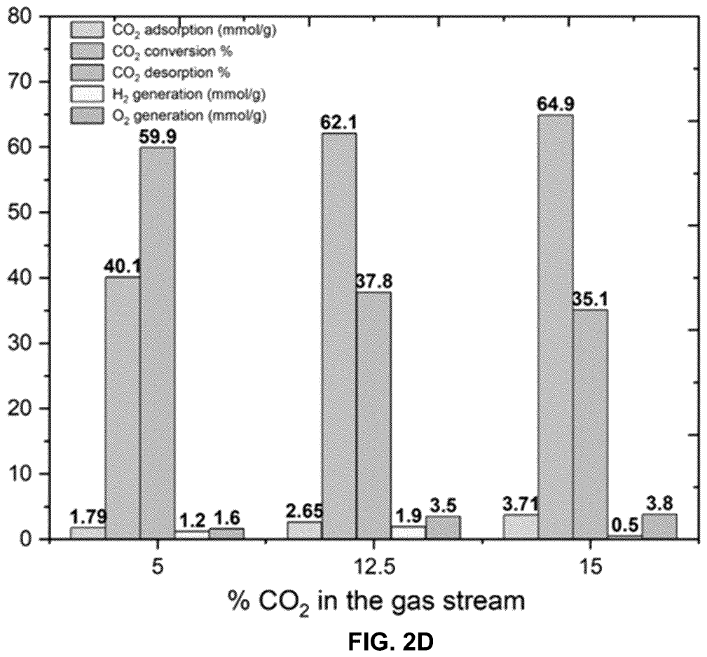

As shown in FIG. 2A, at 30 sccm with 2 A, CO₂ conversion (62.1-73.4%) dominates across the range of CO₂ concentrations. O₂ generation increases steadily with CO₂ concentration, peaking at 15 mmol/g at 16.7%, while H₂ generation decreases. FIG. 2B shows that reducing the current to 1.2 A lowers CO₂ conversion (58.7-63.3%) and O₂ generation compared to 2 A. Adsorption remains low but consistent, ranging from 0.82 to 3.48 mmol/g. FIG. 2C highlights the impact of higher flow rates (40 sccm) with 2 A. CO₂ conversion remains dominant, reaching 73.1% at 12.5% CO₂ and slightly decreasing to 69.7% at 15%. Adsorption and O₂ generation are enhanced at higher concentrations, with O₂ peaking at 10.6 mmol/g. H₂ generation continues to decline as CO₂ concentration rises. In FIG. 2D, at 40 sccm and 1.2 A, CO₂ conversion decreases slightly (59.9-64.9%), while O₂ generation peaks at 3.8 mmol/g. The lower power conditions favor recombination reactions, reducing CO₂ breakdown efficiency compared to higher power settings.

The role of activated carbon as the electrode is examined. There are two hypotheses for the reason of increasing trend of CO₂. Initially, surface carbon detaches from the activated carbon and reacts with oxygen atoms to produce CO₂ during the first phase. Subsequently, the amount of surface carbon decreases, leading to a shift where CO₂ conversion becomes more dominant than surface reactions on the activated carbon. As illustrated in FIGS. 2A-2D, under total flow rates of 30 sccm, the plasma conversion rate dominates over the desorption of CO₂. During the plasma reaction, CO and O are produced as CO₂ reacts with the plasma. Initially, oxygen atoms combine with carbon on the activated carbon surface, detached by the electrical current, generating CO₂. Simultaneously, CO₂ adsorption occurs on the activated carbon surface. Over time, CO₂ generation from oxygen atoms and surface carbon decreases as these resources are consumed through plasma reactions and surface adsorption. A second hypothesis is that surface CO₂ is detached from the surface by initial potential.

The plasma reaction continuously consumes CO₂ and supplies carbon to the activated carbon surface, maintaining its performance. Unlike steel-based electrodes, where solid carbon formation during plasma reactions may obstruct reaction pathways, using carbon foam electrodes ensures sustained plasma reaction efficiency.

FIGS. 2A-2D demonstrate that O₂ generation increases with higher CO₂ concentrations. This occurs as oxygen atoms, produced during the conversion of CO₂ to CO, recombine to form O₂.

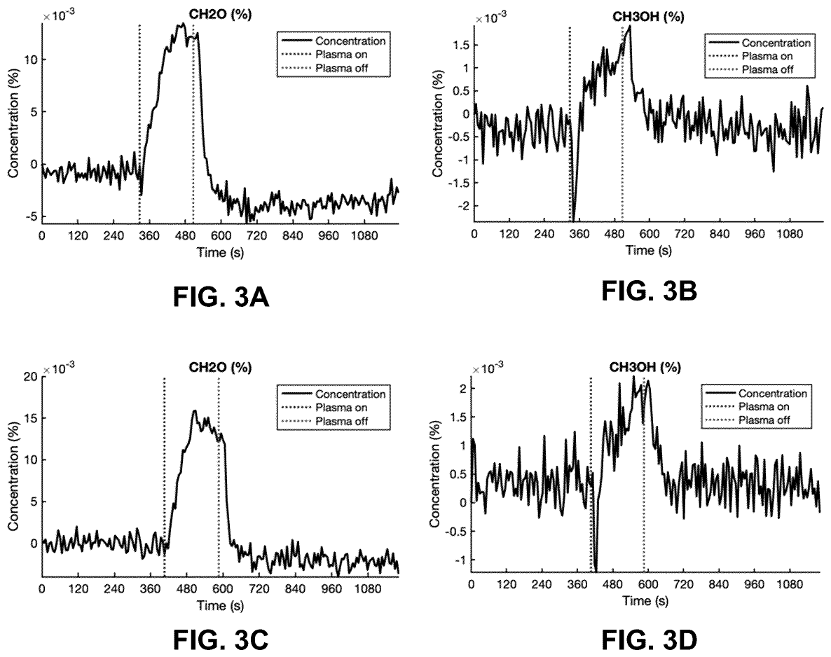

In the case of 30 sccm, 6 V, and 2 A (with moisture), H₂ generation decreases as CO₂ concentration increases, while O₂ generation rises. A comparable pattern is evident in the 40 sccm, 6 V, 2 A (with moisture) scenario, suggesting that higher power facilitates the conversion of hydrogen atoms in the moisture on the activated carbon surface. In this condition, hydrogen atoms do not attach to the oxygen species generated during the plasma reaction but instead react with CO to form products such as formaldehyde and methanol (FIGS. 3A-3D). However, under lower power conditions, hydrogen recombination dominates over reactions with CO.

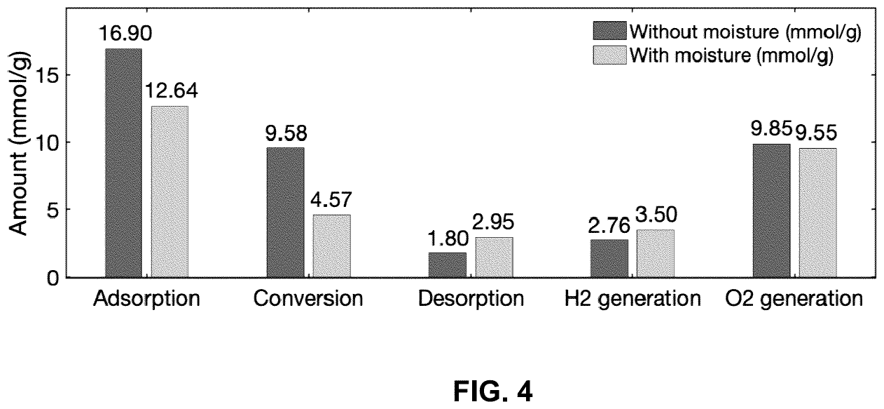

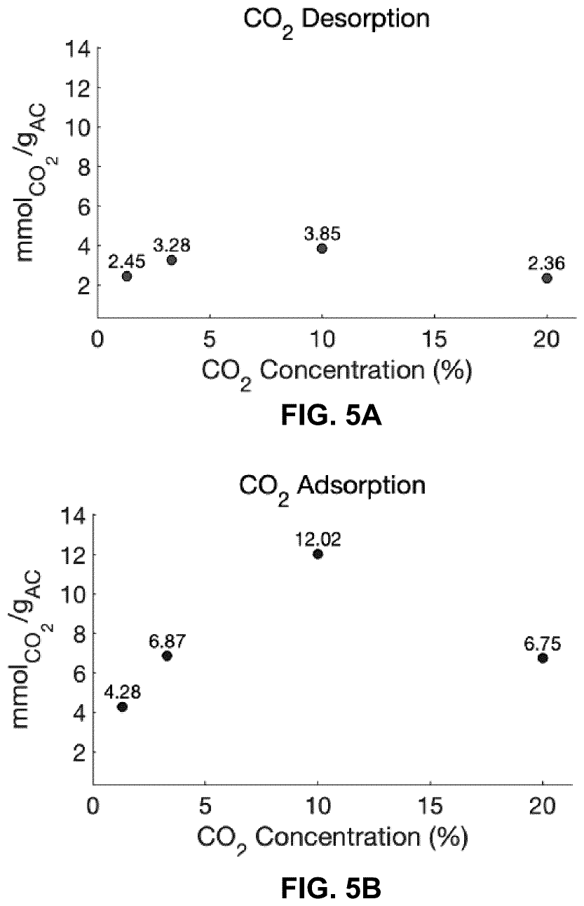

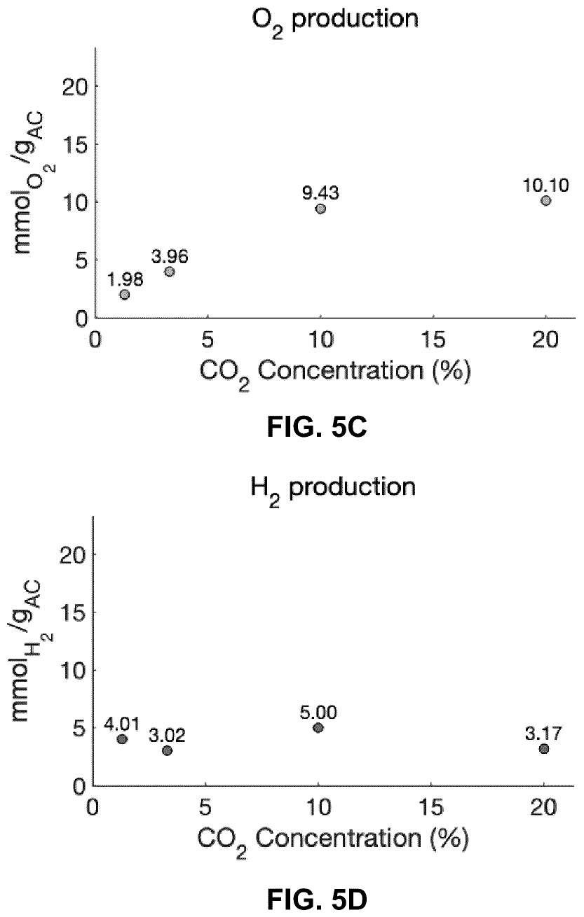

Moisture content in the activated carbon foam was removed using a heating tape to evaluate its impact. Without moisture, CO₂ desorption from surface carbon decreases (FIG. 4), suggesting that moisture facilitates the activation and detachment of surface carbon, potentially by enhancing conductivity. Additionally, CO₂ conversion efficiency improves without moisture, as plasma power is redirected from detaching water vapor to breaking CO₂ bonds. The removal of moisture also creates pores, improving the adsorption performance of the activated carbon foam. As shown in FIG. 4, O₂ generation slightly increases while H₂ generation decreases, indicating that O₂ originates from plasma reactions rather than surface reactions.

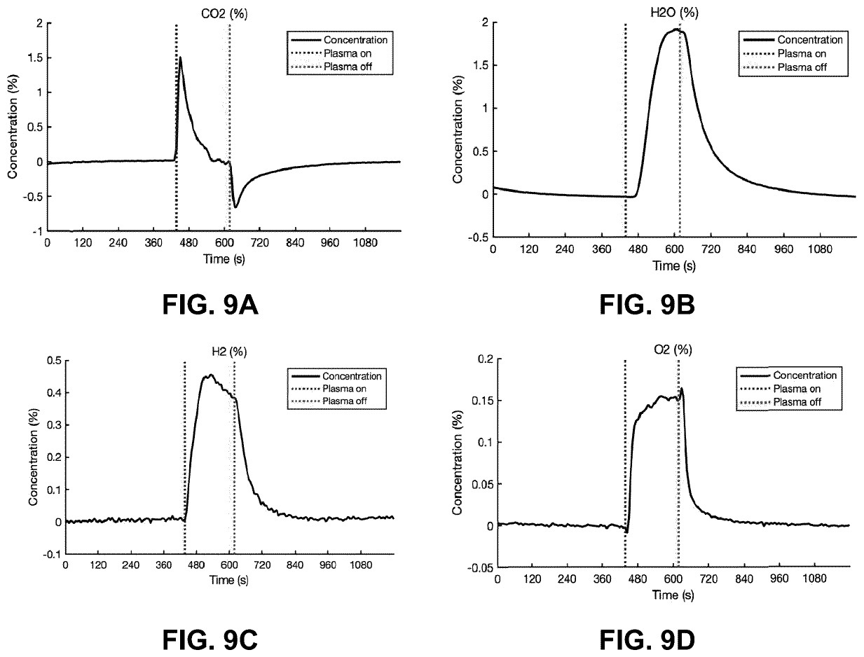

FIGS. 9A-9D demonstrate the effects of ambient moisture being allowed to remain. While the plasma is turned on, the concentration of CO₂ (FIG. 9A) decreases over the course of the period when the plasma is turned on. In contrast, the concentrations of H₂O (FIG. 9B), H₂ (FIG. 9C), and O₂ (FIG. 9D) peak during the time the plasma is turned on.

### Example 2: In-Situ Production of H₂ Using Novel Plasma Technology Under Ambient Conditions

The process produces H₂ using ambient air “native” humidity (moisture) under a plasma and in the presence of structured materials that are sorbents and/or catalytic materials that help adsorbing the water, with the adsorbed water cracked into H₂ and O₂, when the plasma is passed through it. The sorbent and/or catalytic material is sufficiently electrically conductive to function as an electrode for the plasma generation. This process can generate green H₂ if renewable electricity is used as a power source for the plasma.

Conventional processes for green H₂ production relies on water electrolysis, with clean water required to generate the H₂. That process requires a source of water with further added cost of water pretreatment. The methods described and claimed herein do not require such a water source (as the water may simply correspond to the amount of water in ambient air), thereby avoiding the costs associated with water pretreatment required in conventional processes.

The process can be used anywhere in the world with a hot and humid environment to generate H₂. For example, the process can be deployed anywhere on Earth having a reliable source of air with at least some water contained therein. Preferable areas include air having humidity, including, but not limited to, Illinois, Florida, California, Texas, the Carolinas, Louisiana. Preferably, the humidity level of the air introduced to the gas flow cell is between 10% and 80%, such as between 20% and 60%.

The plasma reactor set-up and project can also be utilized as a CO₂ capture and conversion system. While conducting the experiments, it was found that carbon-based sorbents (that also act as an electrode for plasma generation), adsorbs water from the air that is cracked into H₂ and O₂ under plasma conditions. This is the basis for producing H₂ using air's natural humidity level.

### Example 3: Carbon Foams for Production of H₂ Under Ambient Conditions

FIG. 10 shows an exemplary apparatus 1100 for hydrogen generation. Apparatus 1100 comprises a gas flow cell 1102 with an inlet 1104 and an outlet 1106. A structured material 1108 comprising an activated carbon foam is located within gas flow cell 1102. Structured material 1108 has been treated with KOH at a temperature. A plasma source 1110 is integrated with gas flow cell 1102 and is configured to generate a DC arc plasma 1114 within a portion of gas flow cell 1102. Plasma source 1110 comprises electrodes 1112a, 1112b, and 1112c within gas flow cell 1102. In some embodiments, electrode 1112a comprises an electrically-conductive wire bunch, such as copper wires. As previously described, the wires may be characterized by a thickness (e.g., diameter) and the number of wires in the wire bunch. Power source 1114 is configured to provide a DC voltage to electrodes 1112a, 1112b, and 1112c and structured material 1108.

As shown in Table 1, the KOH to activated carbon foam treatment ratio (by mass) and the treatment temperature affects the concentration of generated hydrogen gas provided to outlet 1106.

TABLE 1
KOH treated Carbon Foam

| KOH to | | Total | Humidity | Hydrogen in |
|---|---|---|---|---|
| Foam | Treatment | Feed | in the | the outlet |
| Treatment | Temperature | Flow | flow | (mmol/g of |
| Ratio | (° C.) | (SCCM) | (%) | carbon foam) |
| 3:1 | 650 | 30 | 22 | 4.6 |
| 4:1 | 700 | 30 | 22 | 5.5 |
| 2:1 | 750 | 30 | 22 | 5.9 |
| 3:1 | 800 | 30 | 22 | 9.1 |
| 2:1 | 850 | 30 | 22 | 5.4 |

FIG. 11 shows an exemplary apparatus 1200. Apparatus 1200 comprises a gas flow cell 1202 with an inlet 1204 and an outlet 1206. A structured material 1208 comprising an activated carbon foam is located within gas flow cell 1202. Structured material 1208 has been infused with a Ni—Cu alloy. A plasma source is integrated with gas flow cell 1202 and is configured to generate a DC arc plasma within a portion of gas flow cell 1202. Plasma source comprises electrodes 1212a, 1212b, and 1212c within gas flow cell 1202 and a high voltage power source 1214 to generate current through the gas flow cell. In some embodiments, electrode 1212a comprises an electrically-conductive wire bunch, such as copper wires. As previously described, the wires may be characterized by a thickness (e.g., diameter) and the number of wires in the wire bunch. Power source 1214 is configured to provide a DC voltage to electrodes 1212a, 1212b, and 1212c and structured material 1208.

As shown in Table 2, the use of a Ni—Cu/carbon foam increases the concentration of hydrogen gas provided to outlet 1106 as compared to a control that is a “blank” activated carbon foam.

TABLE 2
Benefits of Ni—Cu/Carbon foam in H₂ production

| | Total | Humidity in | Hydrogen at |
|---|---|---|---|
| | Feed Flow | the flow | the outlet |
| Sample | (SCCM) | (%) | (ppm) |
| Ni—Cu/Carbon Foam | 15 | 100 | 293 |
| | 18 | 100 | 343 |
| Blank Carbon Foam | 16 | 100 | 178 |

The above-described embodiments of the present invention are merely exemplary embodiments, set forth for a clear understanding of various principles of the invention. Many variations and modifications may be made to the above-described embodiments without departing substantially from the spirit and various principles of the invention. All such modifications and variations are intended to be included herein within the scope of this disclosure and the present invention and protected by the following claims.

In a first aspect, a method of converting a water-containing gas is provided, including ambient air that has not undergone any processing. Of course, the methods provided herein are compatible with a range of water-containing gases, including a gas having a user-controlled amount of liquid (e.g., humidity level), including between 15% and 100%, and any subranges thereof, such as between 20% and 50%. The method includes: flowing the gas through a gas flow cell having an inlet, an outlet, and a structured material provided within said gas flow cell, wherein structured material has an electrical conductivity selected from the range of 3×10⁻¹⁵ S/m to 6.3×10⁷ S/m, wherein the structured material is a sorbent material and/or a catalyst material, and wherein the gas comprises H₂O; and generating a plasma within a portion of the gas flow cell, wherein the plasma at least partially interacts with the gas and the structured material, thereby causing conversion of the gas, wherein the conversion of the gas generates H₂. The structured material may comprise a sorbent material. The structured material may comprise a catalyst material. The structured material may comprise a sorbent material and a catalyst material.

In a second aspect according to the method of the first aspect, the H₂ is generated by the decomposition of the H₂O in the gas.

In a third aspect according to any of the previous aspects, the gas further comprises CO₂, Ar, N₂, or a combination thereof.

In a fourth aspect according to any of the previous aspects, the method is for CH₄ conversion, the gas further comprises CH₄, the structured material is a catalyst or a photocatalyst, and the CH₄ conversion generates CO and H₂.

In a fifth aspect according to any of the previous aspects, the method is for NH₃ conversion, the gas further comprises NH₃, the structured material is a catalyst or a photocatalyst, and the NH₃ conversion generates H₂.

In a sixth aspect according to any of the previous aspects, the conversion of the gas further generates O₂.

In a seventh aspect according to any of the previous aspects, the structured material is a sorbent material comprising a zeolite.

In an eighth aspect according to any of the previous aspects, the sorbent material comprises an activated carbon foam.

In a ninth aspect according to any of the previous aspects, the gas has a relative humidity of at least 20%, at least 25%, at least 30%, at least 35%, at least 40%, at least 45%, at least 50%, at least 55%, or at least 60%.

In a tenth aspect according to any of the previous aspects, the gas is flowed into the flow cell at a flow rate selected from the range of 20 sccm to 50 sccm. For example, the flow rate may be selected from the range of 20 sccm to 45 sccm, 20 sccm to 40 sccm, 20 sccm to 35 sccm, 20 sccm to 30 sccm, 25 sccm to 50 sccm, 30 sccm to 50 sccm, 35 sccm to 50 sccm, or 40 sccm to 50 sccm.

In an eleventh aspect according to any of the previous aspects, generating the plasma comprises applying a current selected from the range of 1.0 A to 2.5 A. For example, the current may be selected from the range of 1 A to 2.25 A, 1 A to 2 A, 1 A to 1.75 A, 1 A to 1.5 A, 1.25 A to 2.5 A, 1.5 A to 2.5 A, 1.75 A to 2.5 A, or 2 A to 2.5 A.

In a twelfth aspect according to any of the previous aspects, the plasma is an AC current plasma.

In a thirteenth aspect according to any of the previous aspects, the plasma is a DC current plasma.

In a fourteenth aspect according to any of the previous aspects, the plasma is an arc plasma.

In a fifteenth aspect according to any of the previous aspects, the plasma is characterized by an average temperature selected from the range of 293.15 K to 35273.15 K. For example, the average temperature may be selected from the range of 293.15 K to 30273.15 K, 293.15 K to 20273.15 K, 293.15 K to 10273.15 K, 293.15 K to 5273.15 K, 293.15 K to 1273.15 K, 1273.15 K to 35273.15 K, 5273.15 K to 35273.15 K, 10273.15 K to 35273.15 K, 20273.15 K to 35273.15 K, or 30273.15 K to 35273.15 K.

In another aspect, provided is a system for carrying out any of the methods described herein.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method of converting a water-containing gas, the method comprising:
flowing the water-containing gas through a gas flow cell having an inlet, an outlet, and a structured material provided within the gas flow cell, wherein the structured material has an electrical conductivity selected from the range of 3×10⁻¹⁵ S/m to 6.3×10⁷ S/m, wherein the structured material is a sorbent material and/or a catalyst material; and
generating a plasma within a portion of the gas flow cell, wherein the plasma at least partially interacts with the water-containing gas and the structured material, thereby converting the water-containing gas to generate H₂.

2. The method of claim 1, wherein the H₂ is generated by the decomposition of the water in the water-containing gas.

3. The method of claim 1, wherein the water-containing gas further comprises CO₂, Ar, N₂, or a combination thereof.

4. The method of claim 1, further comprising CH₄ conversion, wherein the water-containing gas further comprises CH₄, wherein the structured material comprises the catalyst or a photocatalyst, wherein the CH₄ conversion generates CO and H₂.

5. The method of claim 1, further comprising NH₃ conversion, wherein the water-containing gas further comprises NH₃, wherein the structured material comprises the catalyst or a photocatalyst, wherein the NH₃ conversion generates H₂.

6. The method of claim 1, wherein the conversion of the water-containing gas further generates O₂.

7. The method of claim 1, wherein the structured material comprises the sorbent material comprising a zeolite.

8. The method of claim 1, wherein the structured material comprises the sorbent material comprising an activated carbon foam.

9. The method of claim 1, wherein the water-containing gas is introduced to the gas flow inlet at a relative humidity of between 20% and 100%.
